(19) United States
(12) Patent Application Publication
(10) Pub. No.: US 2024/0351532 A1
(43) Pub. Date: Oct. 24, 2024

(54) MOLDED CEILING MATERIAL FOR VEHICLE

(71) Applicant: Howa Co., Ltd., Kasugai-shi (JP)

(72) Inventors: Shinobu FUSHIKI, Kasugai-shi (JP); Hideki NAGATA, Kasugai-shi (JP)

(21) Appl. No.: 18/619,674

(22) Filed: Mar. 28, 2024

(30) Foreign Application Priority Data
Apr. 20, 2023 (JP) 2023-069094

(51) Int. Cl. B60R 13/02; B32B 3/26; B32B 5/02; B32B 5/18; B32B 5/24; B32B 5/26; B32B 27/12; B60H 1/24

(52) U.S. Cl. CPC B60R 13/0225; B32B 3/266; B32B 5/02; B32B 5/18; B32B 5/245; B32B 5/26; B32B 27/12; B60H 1/245; B32B 2260/023; B32B 2260/046; B32B 2262/0284; B32B 2262/101; B32B 2266/0278; B32B 2307/724; B32B 2605/003

(57) ABSTRACT

A molded ceiling material for vehicles having a substrate layer containing a porous core layer, a surface member and a ventilation control mechanism to control the ventilation volume that is vented from a cabin side of the surface member to the substrate layer. Sound generated in the vehicle cabin is absorbed by the substrate layer through the ventilation control mechanism. That is, the molded ceiling material is equipped with sound-absorption performance for sound from the cabin side of the vehicle. If the sound-absorption rate is increased, the ventilation volume to the substrate layer is increased. If the sound-absorption rate is decreased, the ventilation volume to the substrate layer is reduced. The sound-absorption rate of the molded ceiling material can be controlled regardless of the thickness of the substrate layer. Consequently, the molded ceiling materials for vehicles can be provided with sound-absorption performance corresponding to the sound-absorption characteristics of the vehicle.

### CROSS-REFERENCE TO RELATED APPLICATIONS

This application claims priority to Japanese patent application serial number 2023-069094 filed Apr. 20, 2023, the contents of which is incorporated herein by reference in its entirety for all purposes.

### BACKGROUND

The present disclosure relates to a molded ceiling material for a vehicle.

Various molded ceiling materials for vehicles have been known. For example, it is known a molded ceiling material for a vehicle in which a glass mat or the like impregnated with thermosetting resin is affixed to the surface of a polyurethane foam. It is possible to reduce the weight of the molded ceiling material and ensure the rigidity of the molded ceiling material by layering a porous material such as polyurethane foam with a fiber reinforcement such as glass mat. A molded ceiling material of a prior art has an impermeable film, which prevents penetration of the thermosetting resin, between the fiber reinforcement and a cover member. Instead of the glass mat, a core material for a molded ceiling material of another prior art has a polycarbonate film layered on both sides of a polyurethane foam.

In the case of a configuration that includes the air-impermeable film, such as the molded ceiling material of prior arts, ventilation to the sound-absorption material portion is blocked by the film. Such a molded ceiling material does not have sufficient sound-absorption performance. Therefore, when sound-absorption performance is required in addition to weight reduction and rigidity assurance of the molded ceiling material, the sound-absorption performance has been improved by, for example, preventing the ventilation to the polyurethane foam by omitting the air-impermeable film in the configuration, or by increasing the thickness of the polyurethane foam.

However, the acoustic performance inside of a vehicle cabin have been improved in recent years, and the frequency characteristics of the sound-absorption of ceilings differ for each vehicle. Accordingly, the required sound-absorption performance of molded ceiling materials differs according to the sound-absorption characteristics of the vehicle. Therefore, it is difficult to provide sound-absorption performance suitable for the sound-absorption characteristics of each vehicle with a molded ceiling material that does not include the air-impermeable film so that ventilation is not impeded. Thus, there was a need for a molded ceiling material for vehicles whose sound-absorption performance can be controlled at least within the range that can be required.

The present disclosure was conceived in view of the above points, and the problem to be solved is to provide a molded ceiling material for a vehicle whose sound-absorption performance can be controlled according to the sound-absorption characteristics of the vehicle.

### SUMMARY

According to one aspect of the present disclosure, a molded ceiling material for a vehicle has a substrate layer, a surface member, and a ventilation control mechanism. The substrate layer includes a porous core layer. The surface member is laminated to a cabin side of the substrate layer. The ventilation control mechanism is configured to control the ventilation volume, which is vented from the cabin side of the surface member to the substrate layer.

The molded ceiling material for vehicles has the ventilation control mechanism configured to control the ventilation volume, which is vented from the cabin side of the surface member to the substrate layer. Therefore, sound generated in the vehicle cabin can be absorbed by the substrate layer of the ventilation control mechanism. The molded ceiling material for vehicles is configured to have the sound-absorption performance for sound from the cabin of the vehicle. If the sound-absorption rate is to be increased, the ventilation volume to the substrate layer can be increased. If the sound-absorption rate is to be decreased, the ventilation volume to the substrate layer can be reduced. In this way, the molded ceiling material has ventilation control function. The sound-absorption rate of the molded ceiling material can be controlled regardless of the thickness of the substrate layer. Thereby, the molded ceiling material for vehicles is provided with sound-absorption performance corresponding to the sound-absorption characteristics of the vehicle.

According to another aspect of the present disclosure, the ventilation control mechanism of the molded ceiling material for vehicles has a film layer, which is made of a sheet-shaped plastic film and arranged between the substrate layer and the surface member. The film layer has a ventilation part configured to allow ventilation from the cabin side of the surface member to the substrate layer through a number of ventilation holes perforated in the thickness direction. The ventilation volume may be controlled by changing the opening rate, which is the rate of the total opening area of the respective openings of the ventilation holes to the area of the ceiling surface of the vehicle.

The ventilation control mechanism has the film layer, whose ventilation volume is controlled according to the sound-absorption characteristics of the vehicle. The film layer is arranged between the substrate layer and the surface member. The film layer has a number of ventilation holes perforated in the thickness direction, constituting a ventilation part that can be vented from the cabin side of the surface member to the substrate layer. Therefore, sound generated in the vehicle cabin can be absorbed by the substrate layer through the ventilation part. In the film layer, the ventilation volume may be controlled by changing the opening rate, which is the rate of the total opening area of the respective openings of the ventilation holes to the area of the ceiling surface of the vehicle. Therefore, the molded ceiling material for vehicles can be provided with sound-absorption performance corresponding to the sound-absorption characteristics of the vehicle.

According to another aspect of the present disclosure, the molded ceiling material for vehicles may be configured to change the opening rate by changing the number of the ventilation holes in the film layer and/or by changing the respective opening diameters of at least some of the ventilation holes in the film layer.

The ventilation control mechanism is configured to change the total opening area of the ventilation holes by changing the respective opening diameters of some or all of the ventilation holes in the film layer, or by changing the number of ventilation holes. That is, the opening rate of the ventilation holes is changed by increasing the opening diameter of the ventilation holes when the ventilation volume is increased and by decreasing the opening diameter of the ventilation holes when the ventilation volume is controlled. Alternatively, the opening rate of the ventilation holes is changed by increasing or decreasing the number of ventilation holes without changing the opening diameter of the ventilation holes. Furthermore, the ventilation control mechanism may change the opening rate of the ventilation holes by combining a change in the opening diameter of the ventilation holes in the film layer with a change in the number of ventilation holes in the arrangement. Therefore, the ventilation volume to the substrate layer can be controlled. The molded ceiling material for vehicles can be provided with sound-absorption performance corresponding to the sound-absorption characteristics of the vehicle.

According to another aspect of the present disclosure, the film layer of the molded ceiling material for vehicles may be configured with a first perforated area with a relatively high density of ventilation holes and a second perforated area with low density of ventilation holes on the ceiling surface of the vehicle.

The film layer has the first perforated area with a relatively high density of ventilation holes and the second perforated area with low density of ventilation holes on the ceiling surface of the vehicle. In the first perforated area, the ventilation volume to the substrate layer is relatively large and the sound-absorption rate is high. On the other hand, in the second perforated area, the ventilation volume to the substrate layer is small and the sound-absorption rate is low. That is, the sound-absorption performance can be controlled for each location in the vehicle cabin by partially varying the number of ventilation holes and their opening rate on the ceiling surface.

According to another aspect of the present disclosure, the film layer of the molded ceiling material for vehicles may be configured with a third perforated area where the ventilation holes are biasedly provided in some areas on the ceiling surface of the vehicle and an unperforated area where the ventilation holes are not provided.

The film layer has the third perforated area and the unperforated area at the ceiling surface of the vehicle. No ventilation holes are provided in the unperforated area. The ventilation holes are biasedly provided in the third perforated area. In the vehicle cabin, the ventilation volume to the substrate layer is relatively suppressed in the unperforated area, resulting in a low sound-absorption rate. On the other hand, the ventilation volume to the substrate layer is higher in the third perforated area than in the unperforated area, resulting in a high sound-absorption rate. Thus, the sound-absorption performance can be controlled for each location in the vehicle cabin.

According to another aspect of the present disclosure, the film layer of the molded ceiling material may have an opening rate in the range of 0.1% to 50% of the ventilation holes to the area of the substrate layer.

The ventilation holes in the film layer have an opening rate in the range of 0.1% to 50%. Therefore, compared to the case where the air-impermeable film or the like is arranged between the substrate layer and the surface member, the ventilation volume to the substrate layer is increased, and excessive ventilation is suppressed. Thereby, the ventilation volume to the substrate layer is controlled appropriately according to the required sound-absorption performance. More suitable sound-absorption performance of the molded ceiling material for vehicles can be obtained.

According to another aspect of the present disclosure, the ventilation control mechanism of the molded ceiling material has the film layer which is arranged between the substrate layer and the surface material in some areas on the ceiling surface of the vehicle. The film layer may comprise a sheet-shaped plastic film. The ventilation volume is controlled by changing the area of the film layer relative to the area of the ceiling surface.

The film layer is arranged in some areas on the ceiling surface of the vehicle. By suppressing the ventilation volume of the film layer to a certain amount, or by preventing ventilation, an area with a low sound-absorption rate is configured. Therefore, by changing the area of the film layer in relation to the ceiling surface of the vehicle, the rate of the area of low sound-absorption rate to the ceiling surface can be changed. Thereby the ventilation volume of the entire ceiling surface can be controlled.

According to another aspect of the present disclosure, the molded ceiling material for vehicles may have the ventilation control layer arranged between the substrate layer and the surface member and comprising the ventilation control mechanism. The ventilation control layer may be a sheet-shaped nonwoven fabric layer. The ventilation control layer has a ventilation part that is air-permeable from the cabin side of the surface member to the substrate layer and the ventilation rate is in the range of 3 to 35 cc/cm²/sec.

The nonwoven fabric layer (the ventilation control layer), whose ventilation rate is controlled according to the sound-absorption characteristics of the vehicle, is arranged between the substrate layer and the surface member. The ventilation rate of the nonwoven fabric layer (the ventilation control layer) from the surface member to the substrate layer is controlled in the range of 3 to 35 cc/cm²/sec. Therefore, compared to the case where the impermeable film or the like is arranged between the substrate layer and the surface member, the ventilation volume to the substrate layer can be increased appropriately, and excessive ventilation can be controlled. Thereby, the ventilation volume to the substrate layer can be controlled appropriately according to the required sound-absorption performance. More suitable sound-absorption performance of the molded ceiling material for vehicles can be obtained.

According to another aspect of the present disclosure, the surface member of the molded ceiling material for vehicles includes the ventilation control layer comprising the ventilation control mechanism. The ventilation control layer has the ventilation part that is ventilatable from the cabin side of the surface member to the substrate layer and has the ventilation rate in the range of 3 to 35 cc/cm²/sec.

The surface member includes the ventilation control layer whose ventilation volume is controlled according to the sound-absorption characteristics of the vehicle. The ventilation control layer is arranged on the cabin side of the substrate layer. Thereby, the surface member also serves as the ventilation control mechanism.

According to another aspect of the present disclosure, the ventilation control layer is arranged in a part of the area of the ceiling surface of the vehicle. The molded ceiling material for vehicles may be configured to control the ventilation volume by changing the area of the ventilation control layer relative to the area of the ceiling surface.

The ventilation control layer is arranged in a part of the ceiling surface of the vehicle. By controlling the ventilation volume of the ventilation control layer to a certain amount, an area with a low sound-absorption rate is configured. Therefore, by changing the area of the ventilation control layer relative to the ceiling surface of the vehicle, the rate of the area of low sound-absorption to the ceiling surface can be changed. Thus, the ventilation volume of the entire ceiling surface can be controlled.

### BRIEF DESCRIPTION OF THE DRAWINGS

FIG. 1 is a schematic view of the cross-sectional structure of a molded ceiling material according to a first embodiment.

FIG. 2 shows an example of an arrangement pattern of ventilation holes in the molded ceiling material according to the first embodiment.

FIG. 3 shows another example of an arrangement pattern of ventilation holes in the molded ceiling material.

FIG. 4 shows another example of an arrangement pattern of ventilation holes in the molded ceiling material.

FIG. 5 shows another example of an arrangement pattern of ventilation holes in the molded ceiling material.

FIG. 6 shows an example of an arrangement of a film layer in the molded ceiling material.

FIG. 7 is a schematic view of a cross-sectional structure of a molded ceiling material according to a second embodiment.

FIG. 8 shows measurement results of sound-absorption rates of Example 1, Comparative Example 1 and Comparative Example 2.

FIG. 9 shows measurement results of sound-absorption rates of Example 2 and Example 3.

FIG. 10 shows a measurement result of a sound-absorption rate of Example 4.

FIG. 11 shows a measurement result of a sound-absorption rate of Example 5.

### DETAILED DESCRIPTION

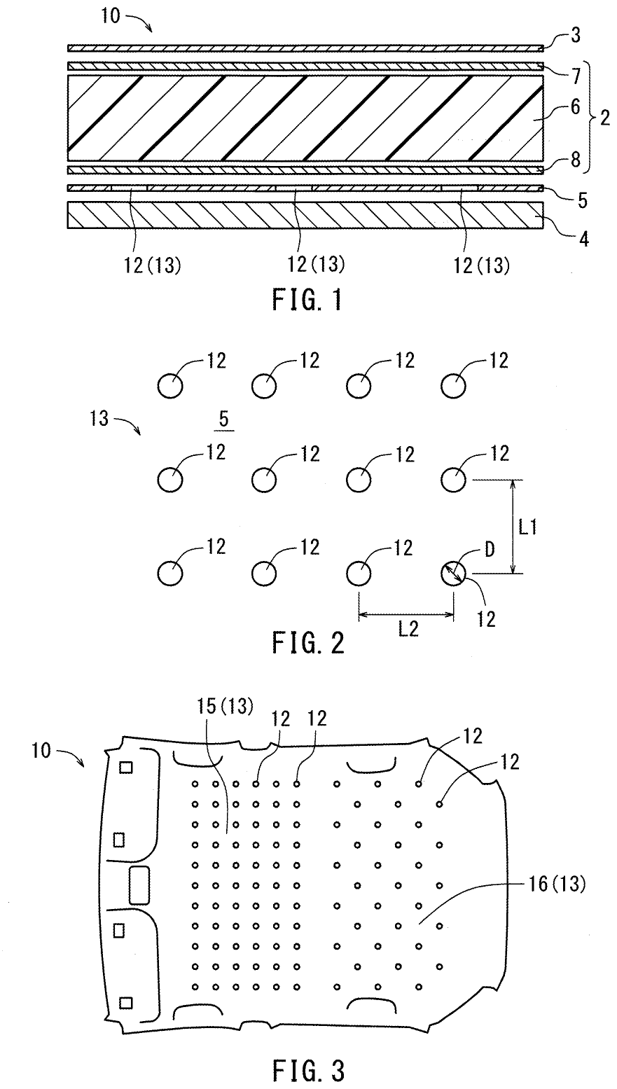

A first embodiment of the present disclosure is described below with reference to FIGS. 1-6. A ceiling panel made of steel plate is used as a roof of a vehicle. A molded ceiling material 10 for a vehicle is a ceiling interior material attached to the cabin side of the ceiling panel. As shown in FIG. 1, the molded ceiling material 10 is formed by heating and pressurizing a laminate containing a substrate layer 2, a back layer 3, a surface member 4, and a film layer 5 (a ventilation control layer), for example, in a heat press.

The substrate layer 2 includes a porous core layer 6, a first fiber-reinforced layer 7, and a second fiber-reinforced layer 8 laminated on both sides of the porous core layer 6. The substrate layer 2 is solidified, for example, with a thermosetting adhesive. The core porous layer 6 is provided to maintain the shape and rigidity of the molded ceiling material 10. The porous core layer 6 is formed into a shape along the surface of the ceiling panel. According to the embodiment, a semi-rigid layer of urethane foam made of urethane resin foam is selected as the porous core layer 6.

The first fiber-reinforced layer 7 is laminated to the outer side of the core material 6. The second fiber-reinforced layer 8 is laminated to the cabin side of the core material 6. The first fiber reinforced layer 7 and the second fiber reinforced layer 8 are provided to maintain the shape and rigidity of the molded ceiling material 10. The first fiber reinforced layer 7 and the second fiber reinforced layer 8 are coated or impregnated with the thermosetting adhesive (the thermoplastic resin) on the surfaces. The fiber reinforced layers 7, 8 are bonded to both sides of the porous core layer 6, respectively. Glass fiber mats are selected for the first fiber reinforcement layer 7 and the second fiber reinforcement layer 8. The glass fiber mats are formed into sheets by solidified chopped strands with a binder. The chopped strands are inorganic glass fiber cut to appropriate lengths.

The first fiber reinforced layer 7 and the second fiber reinforced layer 8 may be made of glass fibers solidified with a binder without cutting (a continuous strand mat). Instead of the continuous strand mat, a spun lace, a spunbonded nonwoven fabric, a glass paper, or glass fiber woven fabric may be used. The basis weight of the embodiment may be selected to meet the required strength and various other conditions.

The fiber-reinforced material used for the first fiber-reinforced layer 7 and the second fiber-reinforced layer 8 may be selected from inorganic fibers such as chopped strands, or organic fibers such as jute, kenaf, ramie, hemp, sisal, bamboo, and other natural fibers. The fiber-reinforced material may be made into sheets or mats by acrylic or other binders or by needling.

The thermosetting resin consisting of isocyanate resin is selected for thermosetting adhesive. Isocyanate is suitable from the viewpoint that it easily blends with the porous core layer 6, which is the semi-rigid layer made of urethane foam. The thermosetting adhesive is not limited to isocyanate resin. The thermosetting adhesive is applied by spray, roll coater, or other means. As described above, it is possible to increase the strength of the molded ceiling material 10 by laminating the fiber reinforced layers 7, 8 containing thermosetting resin and the core material 6.

The back layer 3 is arranged on the outer side of the substrate layer 2. For example, a needle-punched nonwoven fabric or a spun bond nonwoven fabric is selected as the back layer 3. For example, a PET resin fiber nonwoven fabric is selected as the material for the back layer 3. Various synthetic fiber nonwovens, such as polyamide-based, polyester-based, polyacrylonitrile-based, may be applied to the back layer 3.

The surface member 4 is arranged on the cabin side of the substrate layer 2. The surface member 4 is the design surface of the molded ceiling material 10. For example, a surface layer and a urethane foam sheet laminated together is selected as the surface member 4. The surface layer may be fabrics such as fabrics, cloths, and knits, or fabric materials such as woven fabrics, non-woven fabrics, and rare blankets, or synthetic leather, artificial leather, genuine leather, etc. Urethane foam sheets are laminated a soft layer made of urethane resin foam in order to give the molded ceiling material 10 a soft touch. The urethane foam sheet may be configured not to be laminated.

The molded ceiling material 10 may have a ventilation control mechanism, which is configured to control the ventilation volume from the cabin side of the surface member 4 to the substrate layer 2. In other words, the ventilation control mechanism has the function of controlling the ventilation volume from the cabin side of the vehicle to the substrate layer 2 (the ventilation control function). The ventilation control mechanism allows moderate ventilation from the cabin to the substrate layer 2 through the surface member 4. The ventilation control mechanism also controls the excessive ventilation. In this way, the ventilation volume is controlled by the ventilation control mechanism according to the sound-absorption performance of the vehicle. The ventilation control mechanism can make the sound-absorption performance of the molded ceiling material 10 more suitable.

The film layer 5 (the ventilation control layer), which is the ventilation control mechanism, is arranged between the surface member 4 and the substrate layer 2. The film layer 5 is made of, for example, a stretchable plastic film. As shown in FIG. 1, a number of ventilation holes 12 perforated in the thickness direction of the film layer 5 are arranged in the film layer 5. The ventilation hole 12 functions as a ventilation part 13. The ventilation part 13 allows ventilation from the cabin side of the surface member 4 to the substrate layer 2 through the ventilation holes 12. Here, the opening rate is defined as the rate of the total opening area of the respective openings of the ventilation holes 12 combined to the area of the ceiling surface of the vehicle. By changing the opening rate, the ventilation volume to the substrate layer 2 can be controlled. The opening rate of the embodiment is set to conform to the required sound-absorption performance. For example, the ventilation holes 12 are provided so that the opening rate is in the range of 0.1% to 50%. A more suitable opening rate to conform to the required sound-absorption performance is in the range of 0.5% to 20%.

The ventilation hole 12 has, for example, a circular shape. The ventilation holes 12 are provided at arbitrary locations on the ceiling surface. As shown in FIG. 2, the ventilation holes 12 are arranged in a plurality, for example, in a grid pattern in a plan view. The distance L1 between centers of vertically adjacent ventilation holes 12 and the distance L2 between centers of horizontally adjacent ventilation holes 12 are set as the placement intervals. The arrangement interval of the ventilation holes 12 may be set at a constant interval over the entire ceiling surface or as a different interval for each area occupying a part of the ceiling surface. The arrangement pattern of the ventilation holes 12 is not limited to a grid pattern, but may be staggered or otherwise set as appropriate. The opening diameter D of the ventilation holes 12 may be set as appropriate. For example, by making the opening diameter D of each of at least some of the ventilation holes 12 (some or all of the ventilation holes 12) in the film layer 5 larger, the opening rate of the ventilation holes 12 can be increased. By making the opening diameter D of each of the ventilation holes 12 smaller, the opening rate can be decreased. In other words, by changing the opening diameter D of the ventilation holes 12, the opening rate can be changed and the ventilation volume to the substrate layer 2 can be controlled.

The number of ventilation holes 12 in the film layer 5 can be set as appropriate. For example, the opening rate can be increased by increasing the number of ventilation holes 12 without changing the respective opening diameter D of the ventilation holes 12. On the other hand, the opening rate can be decreased by reducing the number of the ventilation holes 12. In other words, the opening rate is changed by changing the number of the ventilation holes in the film layer 5, thereby the ventilation volume can be controlled. The opening rate can also be changed by changing the number of ventilation holes 12 in the film layer 5 along with by changing the respective opening diameter D of at least some of the ventilation holes 12 (some or all of the ventilation holes 12) in the film layer 5.

As shown in FIG. 3, the film layer 5 may have a first perforated area 15 and a second perforated area 16. The first perforated area 15 is an area where the ventilation holes 12 are densely provided on the ceiling surface of the vehicle. The second perforated area 16 is an area where the ventilation holes 12 are sparsely provided. Therefore, the first perforated area 15 has a higher opening rate and a larger ventilation volume than the second perforated area 16. In other words, the ceiling surface may be configured to have different ventilation volumes at different areas. Thereby, the molded ceiling material 10 is configured to have different sound-absorption performance depending on the location in the vehicle cabin. For example, the molded ceiling material 10 is configured to have different sound-absorption performance in the front area and the rear area of the vehicle cabin.

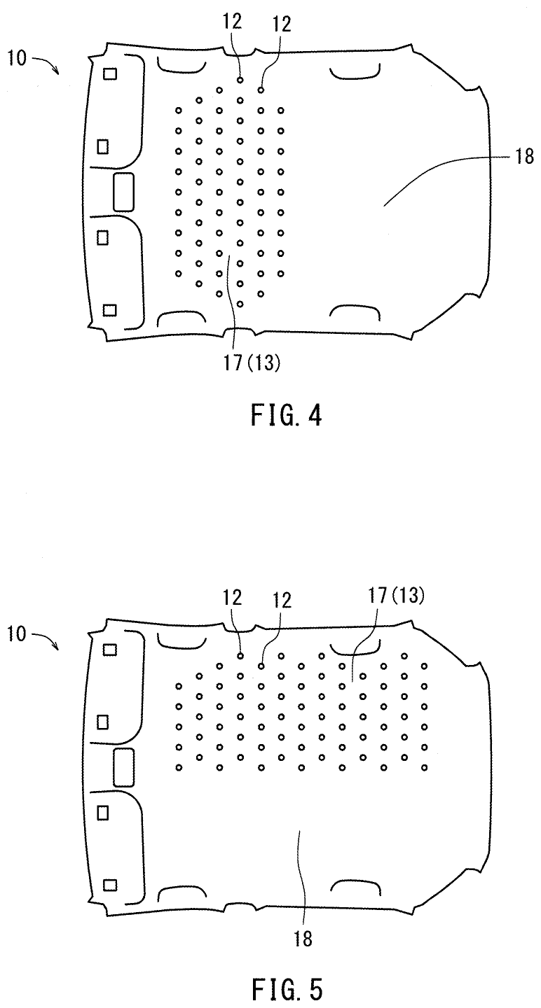

As shown in FIG. 4, the film layer 5 may have a third perforated area 17 and an unperforated area 18. The third perforated area 17 is an area where the ventilation holes 12 are provided in some areas on the ceiling surface of the vehicle. The unperforated area 18 is an area where the ventilation holes 12 are not provided. Therefore, the molded ceiling material 10 can be configured with a certain amount of ventilation from the cabin side of the vehicle to the substrate layer 2 on the ceiling surface to allow sound-absorption and a non-sound-absorption area where ventilation is suppressed. The film layer 5 may be provided with the third perforated area 17 and the unperforated area 18 in the front and rear areas of the vehicle cabin, respectively, as shown in FIG. 4. The film layer 5 may be provided with the third perforated area 17 and the unperforated area 18 in the right side and left side of the vehicle cabin, respectively, as shown in FIG. 5.

The thickness of the film layer 5 is set appropriately. It is possible to control the ventilation volume to the substrate layer 2 by combining the thickness of the film layer 5 and the size and arrangement pattern of the ventilation holes.

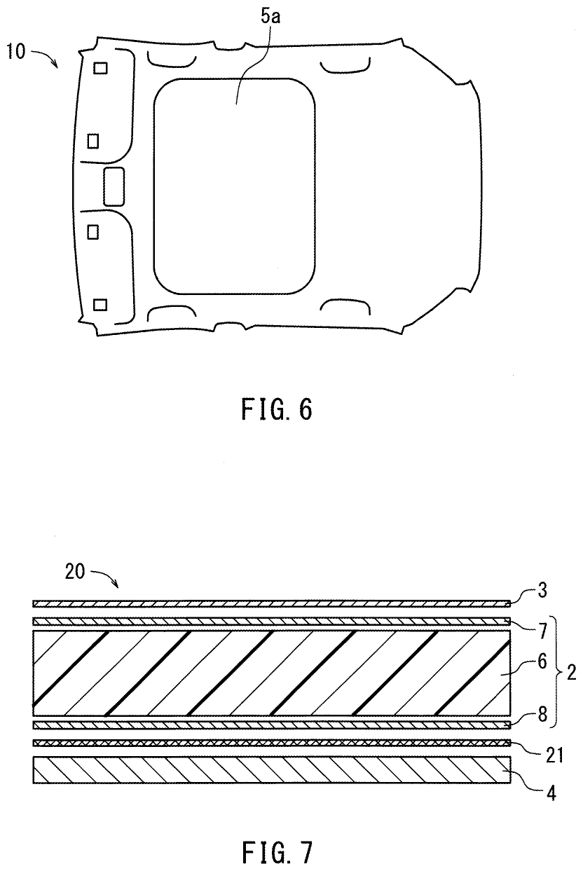

The molded ceiling material 10 may have a film layer 5a in some areas on the ceiling surface of the vehicle, as shown in FIG. 6. The film layer 5a may be an unperforated film having no ventilation holes 12. Thus, by arranging some areas of the ceiling surface with the unperforated film layer 5a so that no ventilation is provided, the areas can constitute non-sound-absorption areas. The area where the film layer 5a is not arranged may be a sound-absorption area. By changing the area of the film layer 5a in relation to the area of the ceiling surface, the rate of the area of the non-sound-absorption area to the ceiling surface can be changed. Thereby the ventilation volume over the entire ceiling surface can be controlled. The film layer 5 with ventilation holes 12 may be arranged in some areas of the ceiling surface. For example, by suppressing the ventilation volume of the film layer 5, the area where the film layer 5 is arranged can be made a non-sound-absorption area.

Next, a second embodiment will be described. A molded ceiling material 20 for a vehicle is a ceiling interior material attached to the cabin side of the ceiling panel. As shown in FIG. 7, the molded ceiling material 20 is formed by heating and pressurizing a laminate containing a substrate layer 2, a back layer 3, a surface member 4, and a nonwoven fabric layer 21 (a ventilation control layer), for example, in a heat press. The description of substantially the same configuration as in the first embodiment is omitted, and the focus will be on the different portions.

As in the first embodiment, the substrate layer 2 includes a first fiber reinforcement layer 7 and a second reinforcement layer 8 laminated on both sides of a core material 6. The substrate layer 2 is solidified with the thermosetting adhesive. The back layer 3 is arranged on the outer side of the substrate layer 2. The surface member 4 is arranged on the cabin side of the substrate layer 2.

The molded ceiling material 20 has a ventilation control mechanism. The ventilation control mechanism can control the ventilation volume from the cabin side of the surface member 4 to the substrate layer 2. That is, the ventilation control mechanism has the function of controlling the ventilation volume from the cabin side of the vehicle to the substrate layer 2 (the ventilation control function). The ventilation control mechanism can make the sound-absorption performance of the molded ceiling material 20 more suitable. Between the surface member 4 and the substrate layer 2 of the molded ceiling material 20, the nonwoven fabric layer 21 is arranged as a ventilation control layer that constitutes the ventilation control mechanism.

A needle-punched nonwoven fabric or a spunbonded nonwoven fabric, which has elasticity and have a thin sheet shape, is selected as the nonwoven fabric layer 21. Polyester, polypropylene, or the like is selected as the material of the nonwoven fabric. The nonwoven fabric layer 21 functions as a ventilation part that can be vented from the cabin side surface of the surface member 4 to the substrate layer 2. The ventilation volume is adjusted by the nonwoven fabric layer 21 so that air does not pass through excessively. By controlling the air-permeability to the substrate layer 2 to an appropriate value, the sound-absorption performance of the molded ceiling material 20 is improved. The air-permeability of the nonwoven fabric layer 21 is set to conform to the required sound-absorption performance. The air-permeability of the nonwoven fabric layer 21 is controlled by changing the thickness of the nonwoven fabric, the overlapping of fibers, the coarseness of the fibers, and basis weight of the nonwoven fabric, or by stacking multiple layers of nonwoven fabric. The molded ceiling material 20 may also be configured to have areas where the air-permeability of the nonwoven fabric layer 21 differs, such as a configuration where the air-permeability differs between the front and the rear areas of the vehicle cabin, or between the left and right sides of the vehicle cabin. The range of air-permeability of the nonwoven fabric layer 21 of the embodiment is, for example, in the range of 3 to 35 cc/cm²/sec, and preferably in the range of 10 to 20 cc/cm²/sec.

The molded ceiling material 20 may have the nonwoven fabric layer 21 arranged in some areas on the ceiling surface. By controlling the ventilation volume of the nonwoven fabric layer 21, the area where the nonwoven fabric layer 21 is arranged may be configured as a non-sound-absorption area and the area where the nonwoven fabric layer 21 is not arranged may be configured as a sound-absorption area. By changing the area of the nonwoven fabric layer 21 relative to the area of the ceiling surface, the rate of the area of the non-sound-absorption area to the ceiling surface can be changed. Thereby, it is possible to control the ventilation volume over the entire ceiling surface.

The molded ceiling material 20 may also be configured so that the surface member 4 includes a ventilation control layer that constitutes a ventilation control mechanism and is arranged on the cabin side of the substrate layer 2. The ventilation control layer has a ventilation part that can be vented from the cabin side of the surface member 4 to the substrate layer 2. Thereby, the ventilation volume is controlled according to the sound-absorption characteristics of the vehicle. For example, the air-permeability of the ventilation control layer is set in the range of 3 to 35 cc/cm²/sec. It may also be set in the range of 10 to 20 cc/cm²/sec. For example, the ventilation volume from the cabin side of the surface member 4 to the substrate layer 2 can be controlled by using the nonwoven fabric included in the surface member 4 as the ventilation control layer as well. The molded ceiling material 20 may also be configured with the ventilation control mechanism by, for example, arranging the surface member 4 made of nonwoven fabric (the ventilation control layer) on the cabin side of the substrate layer 2. In this case, the surface member 4 also functions as the ventilation control layer (the ventilation control mechanism).

The molded ceiling materials 10, 20 for vehicles of the above embodiments have the substrate layer 2 containing the porous core layer 6 and the surface member 4. The molded ceiling materials 10, 20 are provided with the ventilation control mechanism that can control the ventilation volume that is vented from the cabin side of the surface member to the substrate layer 2. Sound generated in the vehicle cabin is absorbed by the substrate layer 2 through the ventilation control mechanism. That is, the molded ceiling materials 10, 20 are equipped with sound-absorption performance for sound from the cabin side of the vehicle. If the sound-absorption rate is to be increased, the ventilation volume to the substrate layer 2 is increased. If the sound-absorption rate is to be decreased, the ventilation volume to the substrate layer 2 is reduced. In this way, the molded ceiling materials 10, 20 achieve ventilation control function. The sound-absorption rate of the molded ceiling materials 10, 20 can be controlled regardless of the thickness of the substrate layer 2. Thereby, the molded ceiling materials 10, 20 for vehicles can be provided with sound-absorption performance corresponding to the sound-absorption characteristics of the vehicle.

The ventilation control mechanism of the above embodiments has the ventilation control layer (e.g., the film layer 5 or the nonwoven fabric layer 21) that is arranged on the cabin side of the substrate layer 2. The ventilation volume of the ventilation control layer is controlled according to the sound-absorption characteristics of the vehicle. The ventilation control layer has the ventilation part 13 that allows ventilation from the cabin side of the surface member 4 to the substrate layer 2. Therefore, sound generated in the vehicle cabin is absorbed by the substrate layer 2 through the ventilation part 13 of the ventilation control layer. The molded ceiling materials 10, 20 are configured to have sound-absorption performance against sound from the cabin side of the vehicle. Furthermore, the ventilation part 13 is configured to control the ventilation volume to be vented through the ventilation part 13. If the sound-absorption rate is to be increased, the ventilation volume to the substrate layer 2 is increased. If the sound-absorption rate is to be decreased, the ventilation volume to the substrate layer 2 is reduced. In this way, the molded ceiling materials 10, 20 achieve ventilation control function.

The ventilation control layer of the above embodiments (e.g., the film layer 5 or the nonwoven fabric layer 21) have elasticity. Therefore, it can easily conform to the shape of the molded ceiling materials 10, 20 and suppress wrinkling and tearing of the ventilation control layer during molding.

According to the molded ceiling material 10 of the first embodiment, the film layer 5 (the ventilation control layer), the ventilation volume of which is controlled according to the sound-absorption characteristics of the vehicle, is arranged between the substrate layer 2 and the surface member 4. The film layer 5 is provided with a number of ventilation holes 12 perforated in the thickness direction, which constitute the ventilation part 13. Thereby, sound generated in the vehicle cabin is absorbed by the substrate layer 2 through the ventilation area 13. The ventilation volume to the substrate layer 2 can be controlled by changing the total opening area, or opening rate, of the ventilation holes 12 in the film layer 5 relative to the area of the vehicle ceiling surface. Thus, the sound-absorption performance of the molded ceiling material 10 can be controlled according to the sound-absorption characteristics of the vehicle.

The molded ceiling material 10 of the first embodiment can change the total opening area of the ventilation holes 12 by changing the respective opening diameters D of some or all of the ventilation holes 12 in the film layer 5. In other words, the opening rate of the ventilation holes 12 is changed by increasing the opening diameter D of the ventilation holes 12 when the ventilation volume is increased and by decreasing the opening diameter D of the ventilation holes 12 when the ventilation volume is suppressed. In this way, the ventilation volume to the substrate layer 2 can be controlled. The sound-absorption performance of the molded ceiling material 10 can be controlled according to the sound-absorption characteristics of the vehicle.

The molded ceiling material 10 of the first embodiment can change the total opening area of the ventilation holes 12 by changing the number of ventilation holes 12 in the film layer 5. The opening rate of the ventilation holes 12 is changed by increasing or decreasing the number of ventilation holes 12 without changing the opening diameter D of the ventilation holes 12. In this way, the ventilation volume to the substrate layer 2 can be controlled. The sound-absorption performance of the molded ceiling material 10 can be controlled according to the sound-absorption characteristics of the vehicle.

The molded ceiling material 10 of the first embodiment can change the opening rate of the ventilation holes 12 by combining a change in the opening diameter D of the ventilation holes 12 in the film layer 5 and a change in the number of ventilation holes 12. Thereby, the ventilation volume to the substrate layer 2 can be controlled. The sound-absorption performance of the molded ceiling material 10 can be controlled according to the sound-absorption characteristics of the vehicle.

The molded ceiling material 10 of the first embodiment may have the first perforated area 15 with a relatively dense arrangement of ventilation holes 12 and the second perforated area 16 with a sparse arrangement of ventilation holes 12 in the film layer 5 at the ceiling surface of the vehicle. In the first perforated area 15, the ventilation volume to the substrate layer 2 is relatively high and the sound-absorption rate is high. On the other hand, in the second perforated area 16, the ventilation volume to the substrate layer 2 is low and the sound-absorption rate is low. In other words, by partially varying the number and opening rate of the ventilation holes 12 in the ceiling surface, the sound-absorption performance can be controlled for each location in the vehicle cabin.

The molded ceiling material 10 of the first embodiment may have the third perforated area 17 and the unperforated area 18 in the film layer 5 at the ceiling surface of the vehicle. No ventilation holes 12 are provided in the unperforated area 18. The ventilation holes 12 are biasedly provided in the third perforated area 17. Therefore, in the unperforated area 18, the ventilation volume to the substrate layer 2 is relatively suppressed and the sound-absorption rate is low. On the other hand, in the third perforated area 17, the ventilation volume to the substrate layer 2 is higher than in the unperforated area 18 and the sound-absorption rate is high. In other words, the sound-absorption performance can be controlled for each location in the cabin.

In the molded ceiling material 10 of the first embodiment, the ventilation holes 12 in the film layer 5 have an opening rate in the range of 0.1% to 50%. Therefore, the ventilation volume to the substrate layer 2 is increased and excessive ventilation can be controlled compared to the case where the unperforated film or the like is arranged between the substrate layer 2 and the surface member 4. Thereby, the ventilation volume to the substrate layer 2 is controlled appropriately according to the required sound-absorption performance, and more suitable sound-absorption performance of the molded ceiling material 10 can be obtained.

The molded ceiling material 10 of the first embodiment may have the film layers 5, 5a arranged in some areas on the ceiling surface of the vehicle. An area with a low sound-absorption rate (the unperforated area) can be formed by suppressing the ventilation volume of the film layers 5, 5a to a certain amount, or by preventing ventilation. Therefore, the rate of the area of the non-sound-absorption area to the ceiling surface can be changed by changing the area of the film layers 5, 5a relative to the ceiling surface of the vehicle. Thereby the ventilation volume across the ceiling surface can be controlled.

In the molded ceiling material 20 of the second embodiment, the nonwoven fabric layer 21 (the ventilation control layer) whose ventilation volume is controlled according to the sound-absorption characteristics of the vehicle is arranged on the cabin side of the substrate layer 2 (for example, between the substrate layer 2 and the surface member 4). The ventilation volume from the surface member 4 to the substrate layer 2 is controlled in the range of 3 to 35 cc/cm²/sec by the nonwoven fabric layer 21 (the ventilation control layer). Therefore, compared to the case where the impermeable film or the like is arranged between the substrate layer 2 and the surface member 4, the ventilation volume to the substrate layer 2 can be increased appropriately, and excessive airflow can be controlled. The ventilation volume to the substrate layer 2 is controlled appropriately according to the required sound-absorption performance. Thereby, more suitable sound-absorption performance of the molded ceiling material 20 can be obtained.

The molded ceiling material 20 of the second embodiment can be configured so that the surface member 4 includes the ventilation control layer (e.g., the non-woven fabric) whose ventilation volume is controlled according to the sound-absorption characteristics of the vehicle and is arranged on the cabin side of the substrate layer 2. Thereby, the surface member 4 is configured to serve as a ventilation control mechanism as well.

In the molded ceiling material 20 of the second embodiment, the nonwoven fabric layer 21 (the ventilation control layer) may be arranged in some areas on the ceiling surface of the vehicle. By controlling the ventilation volume of the nonwoven fabric layer 21 to a certain amount, areas with low sound-absorption (areas of non-sound-absorption) are formed. The rate of the area of the non-sound-absorption area to the ceiling surface can be changed by changing the area of the nonwoven fabric layer 21 relative to the ceiling surface of the vehicle. Thereby, the ventilation volume across the ceiling surface can be controlled.

Examples and comparative examples of the present disclosure will be illustrated below in detail.

### Example 1

Following configuration was used for the molded ceiling material. A standard polyurethane foam core material (specific gravity is 31) for the core layer of the substrate layer, a glass mat (100 gsm) for the fiber reinforcement layer of the substrate layer, a nonwoven or knitted fabric for the surface member, a spun-lace nonwoven fabric or spun-bonded nonwoven fabric for the back layer, and a hole-processed film (a film with ventilation holes) for the ventilation control layer. The hole-processed film has a grid of ventilation holes with an opening diameter of 25 mm. The arrangement interval (distance between the centers of adjacent ventilation holes) is 100 mm in the vertical direction×100 mm in the horizontal direction, and the opening rate is approximately 4.9%. The laminate of these materials was then hot-molded for 33 seconds in a press at 140° C. in the upper die and 130° C. in the lower die.

### Comparative Example 1

As a molded ceiling material with sound-absorption specification, a hole-processed film between the substrate layer and surface member was excluded from the molded ceiling material of Example 1, and hot-molded in the same process as in Example 1.

### Comparative Example 2

As a molded ceiling material with non-sound-absorption specification, instead of the hole-processed film in the molded ceiling material of Example 1, an impermeable film was laminated between the surface member and the substrate layer, and hot-molded in the same process as in Example 1.

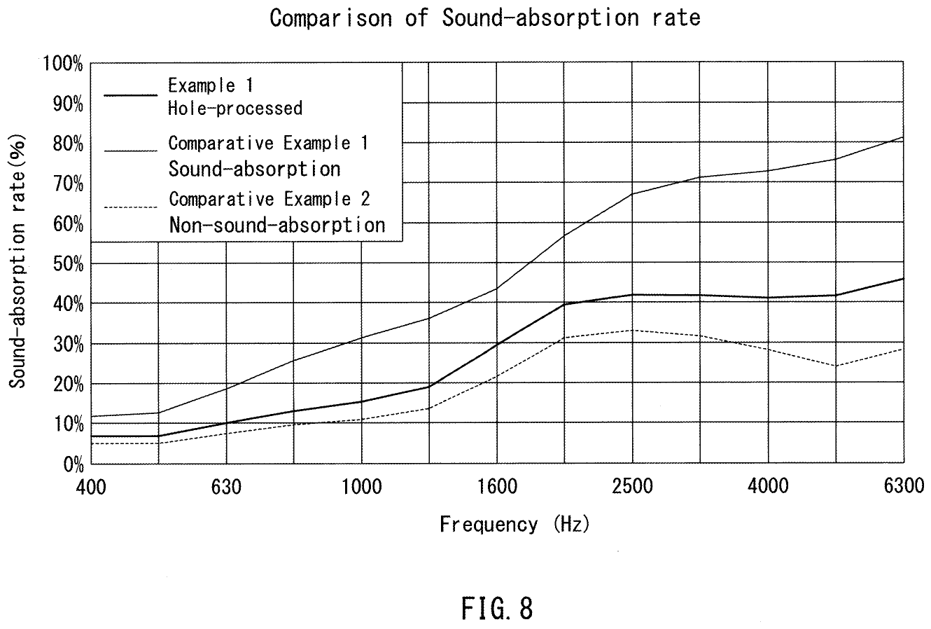

FIG. 8 shows sound-absorption rates of the molded ceiling material of Example 1, Comparative Example 1, and Comparative Example 2. The sound-absorption rate of the molded ceiling material in Example 1 is lower than that of Comparative Example 1 (sound-absorption specification) and higher than that of Comparative Example 2 (non-sound-absorption specification) in the frequency range of 400 Hz to 6300 Hz. That is, according to the molded ceiling material of Example 1, the ventilation volume to the substrate layer is increased more than the non-sound-absorption specification by using a hole-processed film with an opening rate of approximately 4.9%, and excessive ventilation between the substrate layer and the surface member can be suppressed. Therefore, sound-absorption performance between sound-absorbing and non-sound-absorption specifications can be obtained.

### Example 2

A hole-processed film (film with ventilation holes) was used as a ventilation control layer in a molded ceiling material. The opening rate of the hole-processed film is approximately 0.8%. The substrate layer, the surface member, and the back layer are the same as in Example 1.

### Example 3

A hole-processed film (film with ventilation holes) was used as a ventilation control layer in a molded ceiling material. The opening rate of the hole-processed film is approximately 7%. The substrate layer, the surface member, and the back layer are the same as in Example 1.

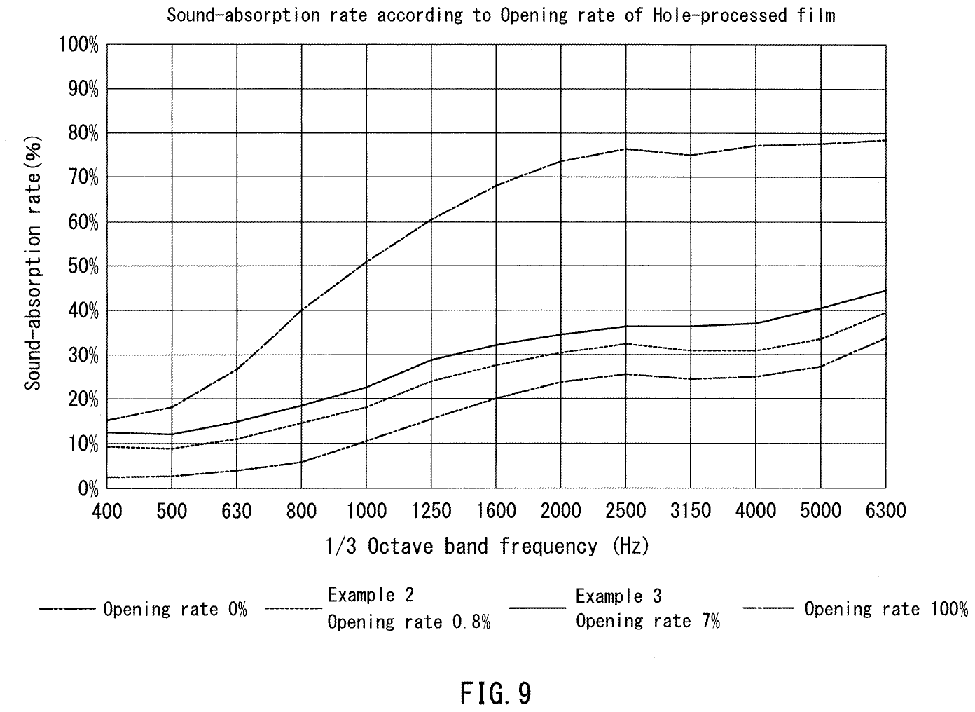

FIG. 9 shows the sound-absorption rates of the molded ceiling material of Example 2 and Example 3, the molded ceiling material with the opening rate of 100% (sound-absorption specification), and the molded ceiling material with the opening rate of 0% (non-sound-absorption specification). The sound-absorption rate of the molded ceiling material of Example 2 is about half or lower than that of the sound-absorption specification in the frequency range of 630 Hz to 6300 Hz. The sound-absorption rate of Example 2 is about of 6 to 9% higher than that of the non-absorbent specification. That is, by using a hole-processed film with an opening rate about of 0.8% for the molded ceiling material of Example 2, the ventilation volume to the substrate layer is moderately suppressed and the sound-absorption performance of the molded ceiling material can be improved compared to the non-absorbent specification.

The sound-absorption rate of the molded ceiling material of Example 3 is about half that of the sound-absorption specification in the frequency range of 630 Hz to 6300 Hz. The ventilation volume of the Example 3 is suppressed. The sound-absorption rate of Example 3 is about 9-15% higher than that of the non-sound-absorption specification. That is, by using a hole-processed film with an opening rate of approximately 7%, the ventilation volume to the substrate layer is moderately suppressed in the molded ceiling material of Example 3 compared to the non-absorbing specification. The sound-absorption performance of the molded ceiling material can be improved. The sound-absorption rate of Example 3 is about 4-6% higher than that of Example 2. That is, by changing the opening rate, the sound-absorption rate can be changed, and the sound-absorption performance of the molded ceiling material can be controlled.

### Example 4

An unperforated film was arranged over the entire ceiling surface or a part of the ceiling surface as a ventilation control layer in a molded ceiling material. The sound-absorption rate was measured by changing the area rate of the unperforated film, i.e., the rate of the area of the molded ceiling material that can absorb sound (sound-absorption area) to the area of the molded ceiling material that does not absorb sound (non-sound-absorption area). The percentages of sound-absorption area and non-sound-absorption area measured were as follows. The below (1) corresponds to the sound-absorption specification. The below (11) corresponds to the non-sound-absorption specification.
(1) Sound-absorption (sound-absorption area):non-sound-absorption
(non-sound-absorption area)=10:0
(2) Sound-absorption:non-sound-absorption=9:1
(3) Sound-absorption:non-sound-absorption=8:2
(4) Sound-absorption:non-sound-absorption=7:3
(5) Sound-absorption:non-sound-absorption=6:4
(6) Sound-absorption:non-sound-absorption=5:5
(7) Sound-absorption:non-sound-absorption=4:6
(8) Sound-absorption:non-sound-absorption=3:7
(9) Sound-absorption:non-sound-absorption=2:8
(10) Sound-absorption:non-sound-absorption=1:9
(11) Sound-absorption:non-sound-absorption=0:10

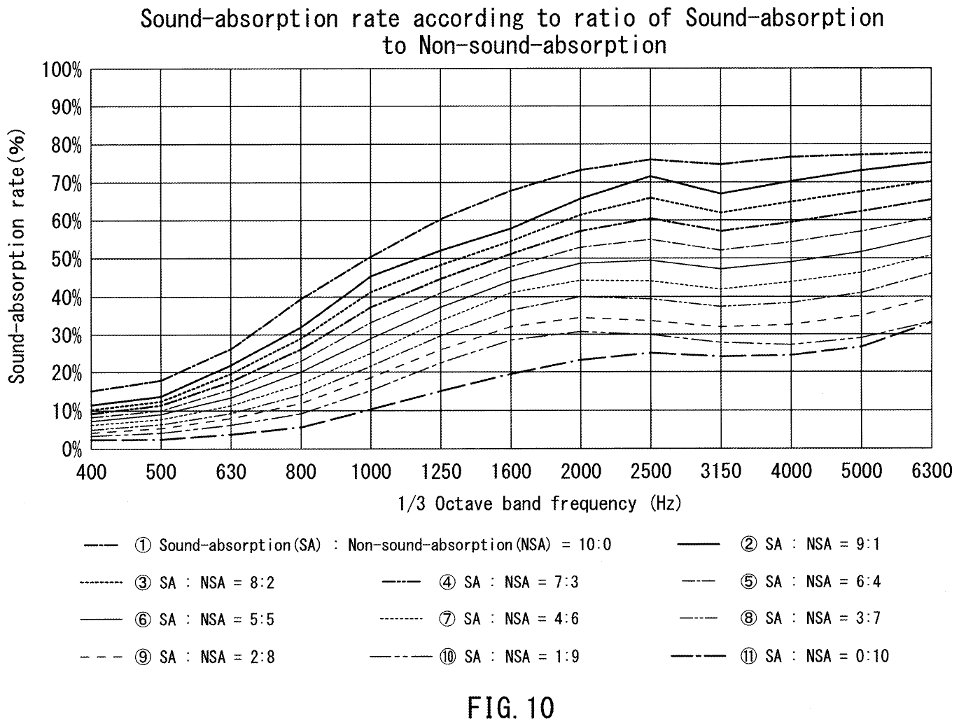

FIG. 10 shows the respective sound-absorption rates of the above (1) to (11). For example, the sound-absorption-rate of (9) where sound-absorption:non-sound-absorption=2:8 is about one-third of the sound-absorption rate of (1) where sound-absorption:non-sound-absorption=10:0 in the frequency range of 400 Hz to 800 Hz. The sound-absorption rate of (9) is about half or lower than the sound-absorption rate of (1) in the frequency range of 1000 Hz to 6300 Hz. It can be recognized that the ventilation volume to the substrate layer is suppressed compared to the sound-absorption specification. The sound-absorption rate of (9) is higher than that of (11) where sound-absorbing:non-absorbing=0:10 in the frequency range of 400 Hz to 6300 Hz. According to the sound-absorbing rates for each rate shown in FIG. 8, the sound-absorption rate increases as the rate of sound-absorbing area increases in the frequency range of 400 Hz to 6300 Hz, and the sound-absorbing rate decreases as the rate of non-sound-absorption area increases. Thus, the sound-absorption performance of the molded ceiling material can be controlled between sound-absorption and non-sound-absorption specifications by changing the rate of sound-absorption and non-sound-absorption areas.

### Example 5

A ventilation-suppressing nonwoven fabric (ventilation volume of 4.5 cc/cm²/sec) was used as a ventilation control layer in a molded ceiling material. The substrate layer, the surface member, and the back layer are the same as in Example 1.

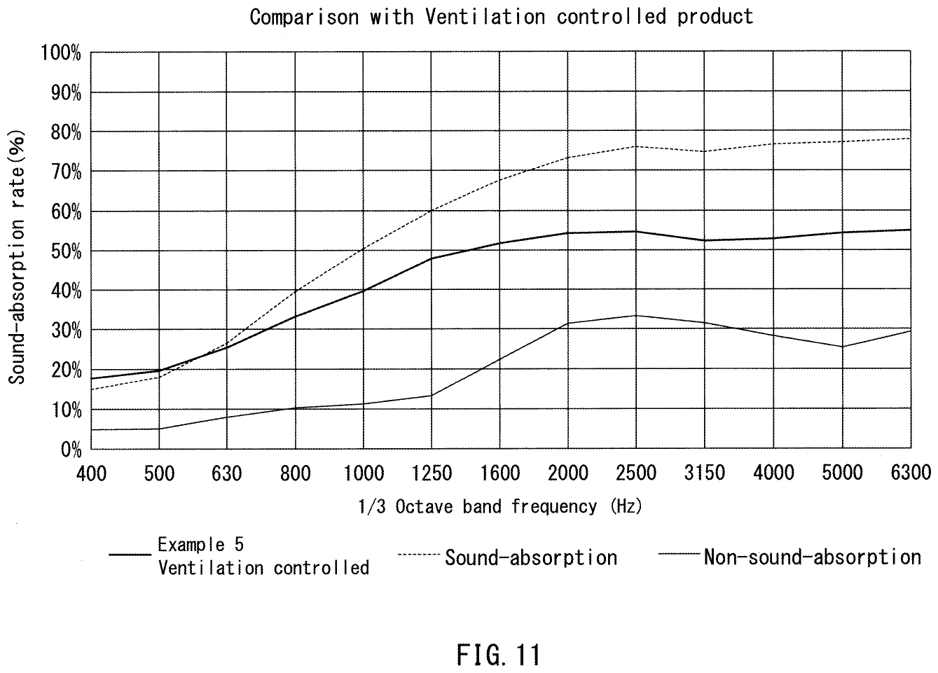

FIG. 11 shows the sound-absorption rate of the molded ceiling material of Example 5, the molded ceiling material with sound-absorbing specification, and the molded ceiling material with non-sound-absorption specification. The sound-absorption rate of the molded ceiling material of Example 5 is about 10-20% lower than that of the sound-absorption specification in the frequency range about 1000 Hz to about 6300 Hz. The sound-absorption rate of Example 5 is about 15-30% higher than that of the non-sound-absorption specification. That is, by using the ventilation volume of 4.5 cc/cm²/sec of the ventilation-suppressing nonwoven fabric for the molded ceiling material of Example 5, the ventilation volume to the substrate layer is moderately suppressed compared to the non-sound-absorption specification, thereby the sound-absorption performance of the molded ceiling material can be improved.

The molded ceiling material for vehicles of the present disclosure is not limited to the appearance and configuration described in the above embodiments, and can be implemented in various other forms by various changes, additions, deletions, and combinations of configurations to the extent that the gist of the invention is not changed.

The film layer (the ventilation control layer) for the first embodiment may be laminated over the entire ceiling surface or over a part of the ceiling surface.

The nonwoven fabric layer (the ventilation control layer) for the second embodiment may be laminated over the entire ceiling surface or over a part of the ceiling surface.

The ventilation control layer of the first and second embodiments may be configured to have different sound-absorption performance in the front and rear of the cabin, or different sound-absorption performance on the left and right sides of the cabin.

The surface member 4 of each of the first and second embodiments may serve as a ventilation control mechanism. For example, in addition to the non-woven fabrics included in the surface member 4, various other materials can work as a ventilation control layer. In this case, the ventilation control layer may be configured to be laminated over the entire ceiling surface or over a part of the ceiling surface.

When the ventilation control layer of the first and second embodiments is arranged in some area of the ceiling surface, the position and size of the area where it is arranged can be set appropriately according to the required sound-absorption performance. For example, a non-absorption area may be provided on either the front or rear side of the cabin, and a non-absorbing area may be provided on either the left or right side of the cabin. Various materials may be used for the non-absorption area, such as ventilation suppressing non-woven fabric, perforated film, unperforated film, etc.

Although embodiments in which the core layer of the urethane foam and the fiber reinforcement material are laminated is shown as the configuration of the substrate layer for the above embodiments, various configurations can be applied without being limited to this configuration. For example, a molded body in which a fiber layer consisting of nonwoven fabric is laminated on both sides of a core layer containing glass fiber and thermoplastic resin, or a molded nonwoven fabric may be selected as the configuration of the substrate layer.

A protective non-woven fabric may be arranged on the cabin side of the substrate layer. The protective non-woven fabric prevents the glass fibers of the coarse-grained glass fiber mat from being exposed and protects the surface of the fiber reinforcement layer.

The various examples described above in detail with reference to the attached drawings are intended to be representative of the present disclosure and are thus non-limiting embodiments. The detailed description is intended to teach a person of skill in the art to make, use, and/or practice various aspects of the present teachings, and thus does not limit the scope of the disclosure in any manner. Furthermore, each of the additional features and teachings disclosed above may be applied and/or used separately or with other features and teachings in any combination thereof, to provide an improved molded ceiling material for a vehicle, and/or methods of making and using the same.

What is claimed is:

1. A molded ceiling material for vehicles, comprising:
a substrate layer including a porous core layer;
a surface member laminated to a cabin side of the substrate layer; and
a ventilation control mechanism configured to control a ventilation volume vented from the cabin side of the surface member to the substrate layer.

2. The molded ceiling material for vehicles according to claim 1, wherein
the ventilation control mechanism has a sheet-shaped plastic film layer arranged between the substrate layer and the surface member, wherein
the sheet-shaped plastic film layer has a ventilation part configured to ventilate from the cabin side of the surface member to the substrate layer through a plurality of ventilation holes perforated in the thickness direction, and wherein
the ventilation volume is controllable by changing an opening rate that is a rate of a total opening area of respective openings of the ventilation holes to the area of the ceiling surface of the vehicle.

3. The molded ceiling material for vehicles according to claim 2, wherein the opening rate is changeable by changing the number of the ventilation holes in the sheet-shaped plastic film layer and/or by changing the respective opening diameters of at least some of the ventilation holes in the sheet-shaped plastic film layer.

4. The molded ceiling material for vehicles according to claim 3, wherein the sheet-shaped plastic film layer has a first perforated area having the ventilation holes arranged in high density and a second perforated area having the ventilation holes arranged in low density.

5. The molded ceiling material for vehicles according to claim 3, wherein the sheet-shaped plastic film layer has a third perforated area where the ventilation holes are biasedly provided in some areas and an unperforated area where the ventilation holes are not provided.

6. The molded ceiling material for vehicles according to claim 2, wherein the sheet-shaped plastic film layer has the opening rate about of 0.1% to about of 50% of the ventilation holes to the area of the substrate layer.

7. The molded ceiling material for vehicles according to claim 3, wherein the sheet-shaped plastic film layer has the opening rate about of 0.1% to about of 50% of the ventilation holes to the area of the substrate layer.

8. The molded ceiling material for vehicles according to claim 4, wherein the sheet-shaped plastic film layer has the opening rate about of 0.1% to about of 50% of the ventilation holes to the area of the substrate layer.

9. The molded ceiling material for vehicles according to claim 1, wherein
the ventilation control mechanism has a sheet-shaped plastic film layer arranged between the substrate layer and the surface material in some areas on the ceiling surface of the vehicle, and wherein
the ventilation volume is controllable by changing the area of the sheet-shaped plastic film layer relatively to the area of the ceiling surface.

10. The molded ceiling material for vehicles according to claim 2, wherein
the ventilation control mechanism has a sheet-shaped plastic film layer arranged between the substrate layer and the surface material in some areas on the ceiling surface of the vehicle, and wherein
the ventilation volume is controllable by changing the area of the sheet-shaped plastic film layer relatively to the area of the ceiling surface.

11. The molded ceiling material for vehicles according to claim 3, wherein
the ventilation control mechanism has a sheet-shaped plastic film layer arranged between the substrate layer and the surface material in some areas on the ceiling surface of the vehicle, and wherein
the ventilation volume is controllable by changing the area of the sheet-shaped plastic film layer relatively to the area of the ceiling surface.

12. The molded ceiling material for vehicles according to claim 1 further comprising a ventilation control layer configured to serve as the ventilation control mechanism and arranged between the substrate layer and the surface member, wherein the ventilation control layer is a sheet-shaped nonwoven fabric layer and has a ventilation part which is ventilatable from the cabin side of the surface member to the substrate layer and the ventilation rate is about of 3 to about of 35 cc/cm²/sec.

13. The molded ceiling material for vehicles according to claim 1, wherein
the surface member includes a ventilation control layer configured to serve as a ventilation control mechanism, and wherein
the ventilation control layer has the ventilation part which is ventilatable from the cabin side of the surface member to the substrate layer and has the ventilation rate about of 3 to about of 35 cc/cm²/sec.

14. The molded ceiling material for vehicles according to claim 12, wherein
the ventilation control layer is arranged in a part of the area of the ceiling surface of the vehicle, and wherein
the ventilation volume is configured to control by changing the area of the ventilation control layer relative to the area of the ceiling surface.

15. The molded ceiling material for vehicles according to claim 13, wherein
the ventilation control layer is arranged in a part of the area of the ceiling surface of the vehicle, and wherein
the ventilation volume is configured to control by changing the area of the ventilation control layer relative to the area of the ceiling surface.

16. A molded ceiling material for vehicles, comprising:
a substrate layer having a porous core layer laminated on two sides by a first fiber-reinforced layer and a second fiber-reinforced layer;
a surface member laminated to a cabin side of the substrate layer; and
a ventilation control mechanism having a film layer configured to control a ventilation volume vented from the cabin side of the surface member to the substrate layer, wherein film layer has a plurality of ventilation holes perforated in a thickness direction, and wherein the film layer has an opening rate about of 0.1% to about of 50% of the plurality of ventilation holes to the area of the substrate layer.

17. The molded ceiling material for vehicles according to claim 16, wherein the first fiber-reinforced layer is laminated to an outer side of the porous core, and wherein the second fiber-reinforced layer is laminated to a cabin side of the porous core.

18. The molded ceiling material for vehicles according to claim 16, wherein the first fiber-reinforced layer and the second fiber-reinforced layer are coated or impregnated with a thermosetting resin includes an isocyanate resin for thermosetting adhesive.

19. The molded ceiling material for vehicles according to claim 16, wherein the film layer is arranged between the surface member and the substrate layer.

20. The molded ceiling material for vehicles according to claim 16, wherein the film layer has a first perforated area and a second perforated area, wherein the plurality of ventilation holes are arranged densely on the first perforated area, and wherein the plurality of ventilation holes are arranged sparsely on the second perforated area.
